(19) United States
(12) Patent Application Publication
(10) Pub. No.: US 2015/0332476 A1
(43) Pub. Date: Nov. 19, 2015

(54) METHOD AND APPARATUS FOR TRACKING OBJECT IN MULTIPLE CAMERAS ENVIRONMENT

(71) Applicant: Electronics and Telecommunications Research Institute, Daejeon (KR)

(72) Inventors: So Hee PARK, Daejeon (KR); Jong Gook KO, Daejeon (KR); Ki Young MOON, Daejeon (KR); Jang Hee YOO, Daejeon (KR)

(73) Assignee: Electronics and Telecommunications Research Institute, Daejeon (KR)

(21) Appl. No.: 14/140,866

(22) Filed: Dec. 26, 2013

(30) Foreign Application Priority Data
Jan. 10, 2013 (KR) 10-2013-0002836

(51) Int. Cl. G06T 7/20; H04N 7/18; G06K 9/00; H04N 5/232; H04N 5/247

(52) U.S. Cl. CPC G06T 7/2033; H04N 5/23296; H04N 5/247; G06K 9/00335; H04N 7/181; G06T 2207/10016

(57) ABSTRACT

The present invention relates to a method of tracking an object in a multiple cameras environment and the method includes generating first feature information of the object from an image input from a first camera; detecting a second camera in which identification information for the object is recognized when the object moves out of a view angle of the first camera, and comparing second feature information of the object generated from an image input from the second camera with the first feature information to track the object from the image input from the second camera. According to the present invention, the object is tracked based on an image in one camera image and if the object moves out of the camera, the identification information of the terminal which is possessed by the object is recognized to hand over the camera to continuously track the same object.

### CROSS-REFERENCE TO RELATED APPLICATIONS

This application claims priority to and the benefit of Korean Patent Application No. 10-2013-0002836 filed in the Korean Intellectual Property Office on Jan. 10, 2013, the entire contents of which are incorporated herein by reference.

### TECHNICAL FIELD

The present invention relates to a method of object tracking in a multiple cameras environment and more specifically, to a technique which, when an object which is tracked by one camera moves to view angle of another camera, precisely and continuously tracks the object. That is, the present invention is to increase the accuracy of object tracking in multiple cameras environment through precise camera handover.

### BACKGROUND ART

Conventional object tracking in multiple cameras environment is based on features of image, that is, tracking method recognizes and tracks the object using color, shape, and texture of image. The feature of image can easily change according to camera's position, illumination change, and other unconstrained environment. Therefore, if the object is moving from one camera to other camera, the possibility of tracking lost is high because of the object recognition error.

### SUMMARY OF THE INVENTION

The present invention has been made in an effort to provide a method and an apparatus which recognize ID information of a terminal which is possessed by an object to hand over a camera when the object moves out of the camera during the tracking of the object in the multiple cameras environment and increase a performance of tracking the object by precisely performing handover.

An object tracking method in a multiple cameras environment according to an exemplary embodiment includes generating first feature information of the object from an image input from a first camera; detecting a second camera in which identification information for the object is recognized when the object moves out of a view angle of the first camera, and tracking the object from the image input from the second camera by comparing second feature information of the object generated from an image input from the second camera with the first feature information.

The tracking may track the object when a similarity of the first feature information and the second feature information is equal to or higher than a predetermined reference value.

The identification information may be recognized by receiving terminal identification information from a terminal provided in the object.

The object tracking method in the multiple cameras environment may further include, prior to the generating of the feature information, extracting the object from the input image, and the generating of the feature information may generate the feature information including the terminal identification information received from the terminal of the extracted object and image feature information of the object.

The detecting of a second camera may include receiving identification information of an object which is present in a view angle of other camera than the first camera and detecting the second camera among other cameras by comparing identification information for an object which moves out of the area with the received identification information of the object.

The detecting of a second camera may track the object by handing over from the first camera to the second camera.

The object tracking method in a multiple object camera may re-perform detecting the second camera when the similarity is lower than the reference value.

An object tracking apparatus in a multiple cameras environment according to an exemplary embodiment may include a feature information generating unit configured to generate first feature information of the object from an image input from a first camera; a camera detecting unit configured to detect a second camera in which identification information for the object is recognized when the object moves out of a view angle of the first camera, and an object tracking unit configured to track the object from the image input from the second camera by comparing second feature information of the object generated from an image input from the second camera with the first feature information.

An object tracking system in a multiple cameras environment according to an exemplary embodiment may include a terminal which includes identification information for an object to be tracked, a plurality of cameras configured to capture an image including the object, and a camera control device configured to track the object from the image captured from the camera to generate feature information of the object and hand over the camera by detecting another camera in which identification information for the object is recognized when the object moves out of a view angle of the one camera.

According to the present invention, the object is tracked based on an image in one camera and if the object moves out of the camera, the identification information of the terminal which is possessed by the object is recognized to hand over the camera to continuously track the same object. When the identification information of the terminal is recognized to hand over the camera, the handover is quickly and precisely performed, which may contribute to increase the performance of tracking the object.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a flowchart illustrating an object tracking method in a multiple cameras environment according to an exemplary embodiment of the present invention.

FIG. 2 is a detailed flowchart illustrating an object tracking method in a multiple cameras environment according to the exemplary embodiment of the present invention.

FIGS. 3A, 3B, and 3C are views illustrating movement of the object in the multiple cameras environment according to an exemplary embodiment of the present invention.

FIG. 4 is a block diagram illustrating an object tracking apparatus in a multiple cameras environment according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The following description illustrates only a principle of the present disclosure. Therefore, it is understood that those skilled in the art various may implement the principle of the present invention and invent various apparatuses which are included in a concept and a scope of the present disclosure even though not clearly described or illustrated in the specification. It is further understood that all conditional terms and exemplary embodiments which are described in the specification are intended to understand the concept of the invention but the present invention is not limited to the exemplary embodiments and states described in the specification.

The above objects, features, and advantages will be more obvious from the detailed description with reference to the accompanying drawings, and may be easily implemented by those skilled in the art. However, in describing the present invention, if it is considered that description of related known configuration or function may unnecessarily cloud the gist of the present invention, the description thereof will be omitted. Hereinafter, an exemplary embodiment of the present disclosure will be described in detail with reference to the accompanying drawings.

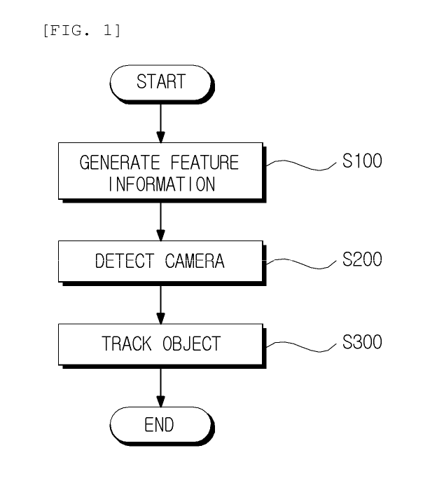

FIG. 1 is a flowchart illustrating an object tracking method in a multiple cameras environment according to an exemplary embodiment of the present invention.

Referring to FIG. 1, an object tracking method in a multiple cameras environment according to the exemplary embodiment includes a feature information generating step S100, a camera detecting step S200, and an object tracking step S300.

In the exemplary embodiment, the feature information generating step S100 is a step of generating feature information including image feature information and object identification information. First image feature information of the object in the image input from a first camera is generated. The first camera is a camera which is currently capturing an object to be tracked among a plurality of cameras included in the multiple cameras environment. In the image feature information generating step, an image including the object captured by the first camera is input. The first feature information including the identification information of the object and the image feature information is generated.

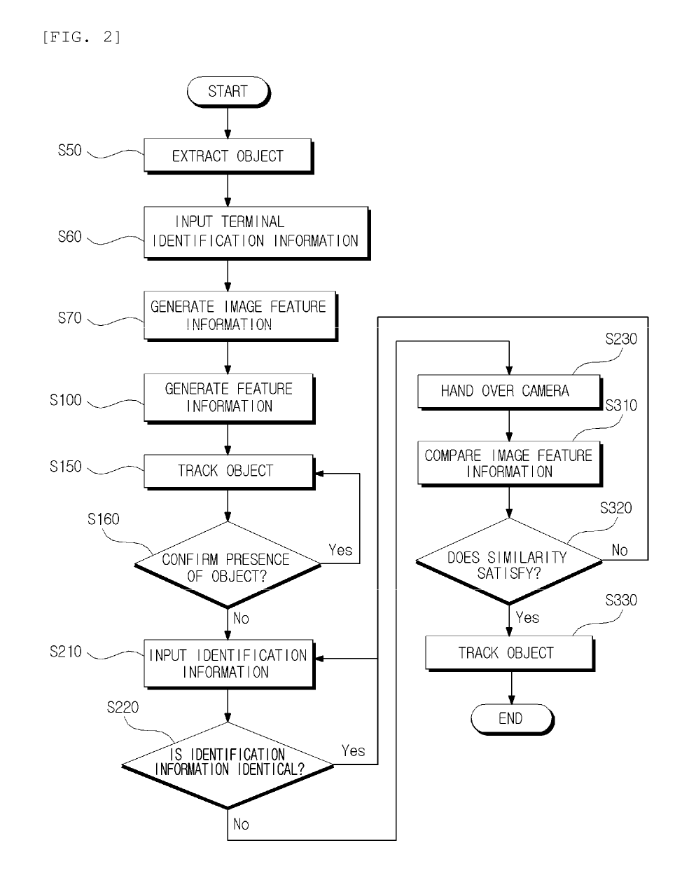

Referring to FIG. 2 which is a detailed flowchart illustrating the object tracking method in a multiple cameras environment according to the exemplary embodiment of the present invention, the object tracking method further includes, prior to the feature information generating step S100, an object extracting step S50, a terminal identification information input step S60, and an image feature information extracting step S70.

In the object extracting step S50, an object to be tracked is extracted from the image input through the first camera.

In the terminal identification information input step S60, the terminal identification information is input from a terminal of the extracted object. That is, in the exemplary embodiment, the object possesses a terminal such as an RFID equipment or a smart phone and in the terminal identification information input step, identification information such as an ID which distinguishes the RFID equipment or the smart phone is input. That is, the object tracking method of the exemplary embodiment indirectly uses identification information of the terminal which is possessed by the object in order to verify whether the objects captured by the plurality of cameras are identical to each other.

In the image feature information generating step S70, a feature value of the object, that is, image information for tracking the object is generated from the input image. The image information may include color information, shape information, and texture information.

Therefore, in the feature information generating step S100 of the exemplary embodiment, feature information of the object is generated as information including the input terminal information and the extracted image feature information.

Further, in the camera detecting step S200 of the exemplary embodiment, if the object moves out of the view angle of the first camera, a second camera in which identification information for the object is recognized is detected.

That is, if the object which is tracked by one camera moves to view angle of another camera, the object tracking method of the exemplary embodiment needs to detect whether the object moves out of the view angle of the camera in order to continuously and precisely track the object.

Therefore, referring to FIG. 2, prior to the camera detecting step, the object tracking method of the exemplary embodiment includes an object tracking step S150 and an object presence confirming step S160.

In the exemplary embodiment, in the object tracking step S150, change of the extracted object is tracked using the image feature information in the first camera.

The object presence confirming step S160 is performed together with the object tracking step, and confirms whether the object moves out of an view angle which may be captured by the first camera while tracking the change of the object. That is, if the image feature information of the object is not detected from the image input from the first camera any more or only feature information which is below a predetermined level is detected, it is confirmed that the object moves out of the view angle of the first camera so that the object is not present.

The object tracking step S150 and the object presence confirming step S160 are continuously and reflexively performed while the object is present in the input image.

That is, in the exemplary embodiment, the camera detecting step S200 is performed when it is confirmed that the object is not present.

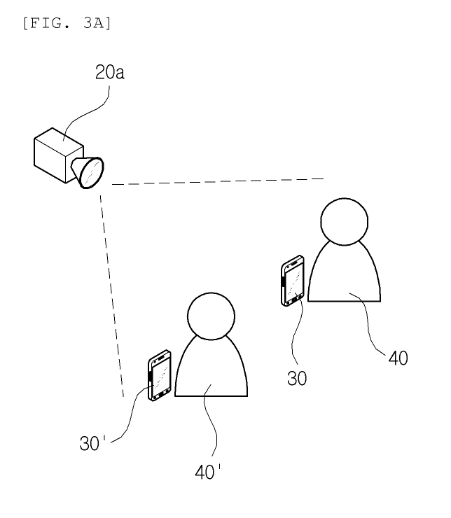

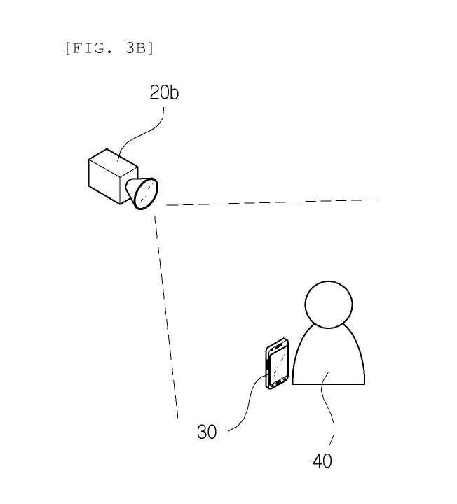

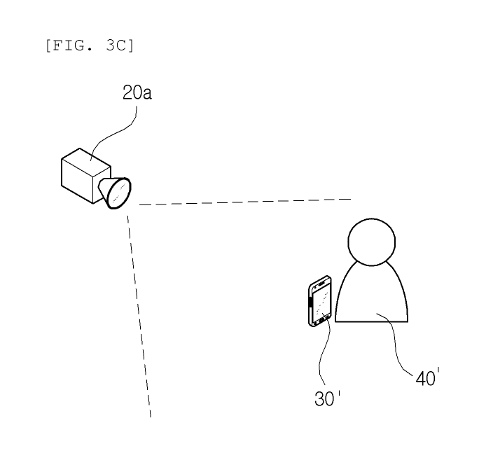

In the camera detecting step S200, it is detected that the object which moves out of the first camera moves in a view angle of any one of the plurality of cameras, which will be described in more detail with reference to FIG. 3.

FIG. 3 is a view illustrating a movement of an object in a multiple cameras environment according to an exemplary embodiment of the present invention.

Referring to FIG. 3A, a person A 40 and a person B 40′ as objects to be tracked are present in the view angle of the first camera 20a. In this case, in the terminal identification information input step S60, IDs of terminals 30 and 30′ which are possessed by the persons are read through a first ID reader to be input as terminal identification information.

Further, in the image feature information generating step S70, image feature information of the person is generated to generate first feature information including the terminal identification information and the image feature information.

If the person A 40 and the person B 40′ who are present in the area of the first camera 20a move out of the view angle of the first camera 20a, the IDs of the terminals 30 and 30′ possessed by the objects are confirmed through the ID reader and a camera area where IDs of the same terminal 30 and 30′ are present is confirmed to hand over the camera using a camera control function so that the person A and the person B may be continuously tracked through a second camera 20b and a third camera 20c, respectively.

That is, the handover in the exemplary embodiment means the synchronization between cameras for continuously tracking the objet in accordance with the movement of the object in the multiple cameras environment. That is, as illustrated in FIG. 3, even though the person A 40 moves from the first camera 20a area to the second camera 20b area, the entire object tracking system recognizes the movement of the person A 40 and generates continuous object tracking information through the synchronization of the first camera 20a and the second camera 20b.

Referring to FIG. 2 again, the camera detecting step of the exemplary embodiment includes an identification information input step S210, an identification information identity confirming step S220, and a camera handover step S230.

In the exemplary embodiment, in the identification information input step S210, identification information of an object which is present in a view angle of other camera than the first camera is input. That is, in order to detect a camera which is capable of capturing an area where the object moves, identification information of the object which is present in a view angle of each of the plurality of cameras included in the multiple cameras environment according to the exemplary embodiment is input.

Next, in the identification information identity confirming step S220, the input identification information is compared with the identification information of the object to be tracked to confirm whether the objects are identical to each other.

If the identification information is identical, the moved object is present in a view angle of a camera to which the identical identification information is input so that the object is tracked by handing over from the first camera.

That is, in the exemplary embodiment, the identification information for an object which moves out of the area is compared with the input identification information of the object to detect a second camera which is capable of capturing an area where the object newly enters, among another cameras.

Hereinafter, the object tracking step S300 by the detected second camera will be described.

In the exemplary embodiment, in the object tracking step S300, the second feature information of the object generated from the image input from the second camera is compared with the first feature information to track the object in the image input from the second camera.

In the exemplary embodiment, the second feature information is generated through the object extracting step S50, the terminal identification information input step S60, and the image feature information extracting step S70. That is, in the object tracking step S300, the first image feature information extracted from an image input through the first camera is compared with the second image feature information extracted from an image input from the detected second camera to determine whether to track the object.

That is, in the objet tracking step S200, if a similarity of the first image feature information and the second image feature information is equal to or higher than a predetermined reference value, the object is tracked. Therefore, referring to FIG. 2, the object tracking step S300 of the exemplary embodiment includes an image feature information comparing step S310, a similarity satisfaction confirming step S320, and a object tracking step S330.

In the image feature information comparing step S310, image feature information included in the first feature information is compared with image feature information included in the second feature information to calculate the similarity.

In the similarity satisfaction confirming step S320, the calculated similarity is compared with a predetermined conditional value and if the calculated similarity is equal to or higher than the conditional value, it is confirmed that the similarity is satisfied.

If the similarity is satisfied, it is determined that the object of the first camera is identical to the object of the second camera, but if not, it is determined that the object of the first camera is not identical to the object of the second camera. That is, the object tracking method according to the exemplary embodiment primarily determines the identity of the object in the image before movement and the object in the image after movement through the terminal identification information and secondarily verifies the identity of the objects through the image feature information of the objects in the images.

The image information frequently varies depending on the position where the camera is installed or the image characteristic. Therefore, if the object is tracked while moving the camera, an error which may occur while identically recognizing and continuously tracking the object may be further reduced.

Thereafter, in the object tracking step S330, if the objects are verified to be identical through the similarity satisfaction confirming step, the object is tracked in the image input through the second camera.

As described above, the method of tracking an object in a multiple cameras environment uses only image information or a method of recognizing a smart terminal to estimate a position. When only the image information is used, there are many errors to recognize whether the objects are identical because the feature of the object frequently varies depending on the position where the camera is installed and the characteristic of the camera. When the smart terminal is used, if there are several terminals, there are many errors to estimate the position due to the interference of the signals. According to the present invention, in order to overcome the limitation of the above-mentioned two methods, the object is tracked based on an image in one camera image and if the object moves out of the camera, the ID of the terminal which is possessed by the object is recognized to hand over the camera to continuously track the identical object. When the ID of the terminal is recognized to hand over the camera, the handover is quickly and precisely performed, which may contribute to increase the performance of tracking the object.

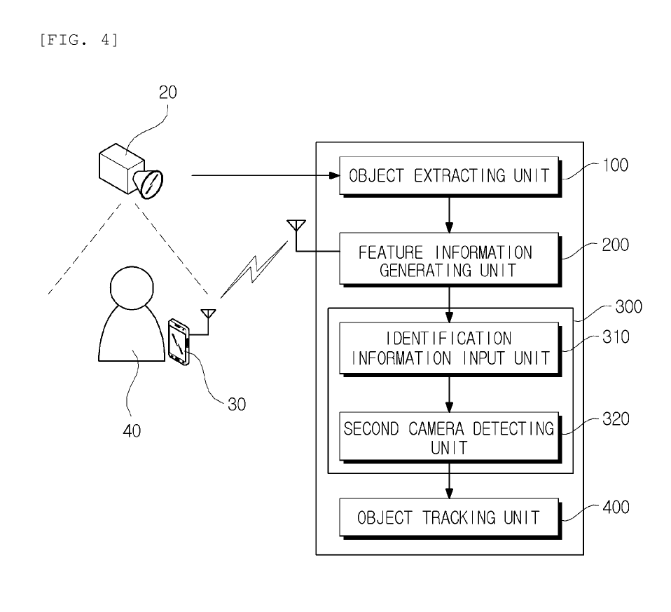

Hereinafter, an object tracking apparatus which performs the object tracking method in the multiple cameras environment according to the exemplary embodiment will be described with reference to FIG. 4.

Referring to FIG. 4, the object tracking apparatus 100 in the multiple cameras environment according to an exemplary embodiment of the present invention includes an object extracting unit 100, a feature information generating unit 200, an identification information input unit 310, a second camera detecting unit 320, and an object tracking unit 400.

The object extracting unit 100 extracts an object from an image input through the first camera.

The feature information generating unit 200 generates the feature information including the terminal identification information input from the terminal of the extracted object and image feature information of the object.

Further, the camera detecting unit 300 detects a second camera in which the identification information of the object is recognized when the object moves out of a view angle of the first camera and includes an identification information input unit 310 and a second camera detecting unit 320.

Specifically, the identification information input unit 310 receives identification information of an object which present in a view angle of other camera than the first camera.

The second camera detecting unit 320 compares the identification information for the object which moves out of the area with the input identification information of the object to detect the second camera among the other cameras.

The object tracking unit compares the second feature information of the object generated from the image input from the second camera with the first feature information to track the object in the image input from the second camera.

The configuration of the object tracking apparatus 100 in the multiple cameras environment according to the exemplary embodiment performs corresponding steps of the object tracking method in the multiple cameras environment of the exemplary embodiment and the redundant description will be omitted.

However, the object tracking method in the multiple cameras environment of the present disclosure may be implemented as a computer readable code in a computer readable recording medium. The computer readable recording medium includes all types of recording device in which data readable by a computer system is stored.

Examples of the computer readable recording media include an ROM, an RAM, a CD-ROM, a magnetic tape, a floppy disk, and an optical data storage device and the computer readable recording media is distributed into a computer systems connected through a network and a computer readable code is stored and executed therein by a distribution method. Further, a functional program, code, and code segment which may implement the present invention may be easily deducted by a programmer in the art.

The above description is illustrative purpose only and various changes, modifications, and variations become apparent to those skilled in the art within a scope of an essential characteristic of the present invention.

Therefore, as is evident from the foregoing description, the exemplary embodiments and accompanying drawings disclosed in the present invention do not limit the technical spirit of the present invention. The scope of the present invention may be interpreted by the appended claims and the technical spirit in the equivalent range is intended to be embraced by the invention.

What is claimed is:

1. An object tracking method in a multiple cameras environment, the method comprising:
generating first feature information of the object from an image input from a first camera;
detecting a second camera in which identification information for the object is recognized when the object moves out of a view angle of the first camera, and
tracking the object from the image input from the second camera by comparing second feature information of the object generated from an image input from the second camera with the first feature information.

2. The method of claim 1, wherein, in the tracking, if a similarity of the first image feature information and the second image feature information is equal to or higher than a predetermined reference value, the object is tracked.

3. The method of claim 1, wherein the identification information is recognized by receiving terminal identification information of a terminal which is provided in the object.

4. The method of claim 3, further comprising:
prior to the generating of the feature information,
extracting the object from the input image, and
wherein the generating of the feature information generates the feature information including the terminal identification information received from the terminal of the extracted object and image feature information of the object.

5. The method of claim 1, wherein the detecting of a second camera includes:
receiving identification information of an object which is present in a view angle of other camera than the first camera; and
detecting the second camera among other cameras by comparing identification information for an object which moves out of the area with the received identification information of the object.

6. The method of claim 5, wherein the detecting of a second camera tracks the object by handing the first camera over to the second camera.

7. The method of claim 2, further comprising:
if the similarity is lower than the reference value, re-performing the detecting of a second camera.

8. An object tracking apparatus in a multiple cameras environment, comprising:
an feature information generating unit configured to generate first feature information of the object from an image input from a first camera;
a camera detecting unit configured to detect a second camera in which identification information for the object is recognized when the object moves out of a view angle of the first camera, and
an object tracking unit which tracks the object from the image input from the second camera by comparing second feature information of the object generated from an image input from the second camera with the first feature information.

9. The apparatus of claim 8, wherein if a similarity of the first image feature information and the second image feature information is equal to or higher than a predetermined reference value, the object tracking unit tracks the object.

10. The apparatus of claim 8, wherein the identification information is recognized by receiving terminal identification information of a terminal which is provided in the object.

11. The apparatus of claim 10, further comprising:
an object extracting unit which extracts the object from the input image,
wherein the feature information generating unit generates the feature information including the terminal identification information received from the terminal of the extracted object and image feature information of the object.

12. The apparatus of claim 9, wherein the camera detecting unit includes:
an identification information input unit which receives identification information of an object which is present in a view angle of other camera than the first camera; and
a second camera detecting unit which detects the second camera among other cameras by comparing identification information for an object which moves out of the area with the received identification information of the object.

13. The apparatus of claim 12, wherein the second camera detecting unit tracks the object by handing the first camera over to the second camera.

14. The apparatus of claim 9, wherein if the similarity is lower than the reference value, the camera detecting unit redetects the second camera.

15. An object tracking system in a multiple cameras environment, comprising:
a terminal which includes identification information for an object to be tracked,
a plurality of cameras configured to capture an image including the object, and
a camera control device configured to track the object from the image captured from the camera to generate feature information of the object and hand over the camera by detecting another camera in which identification information for the object is recognized when the object moves out of a view angle of the one camera.

16. The system of claim 15, wherein if a similarity of image feature information of the object in the one camera and image feature information of the object in another camera is equal to or higher than a predetermined reference value, the camera control device tracks the object.

17. A computer readable recording medium in which a program is stored, the program performing an object tracking method in a multiple cameras environment, comprising:
generating first feature information of the object from an image input from a first camera;
detecting a second camera in which identification information for the object is recognized when the object moves out of a view angle of the first camera, and
tracking the object from the image input from the second camera by comparing second feature information of the object generated from an image input from the second camera with the first feature information.
